(19) United States
(12) Patent Application Publication
(10) Pub. No.: US 2023/0215291 A1
(43) Pub. Date: Jul. 6, 2023

(54) SYSTEM AND METHOD FOR DETERMINING THE LOCATION AND INSTALLATION TECHNIQUES OF ACCESSIBILITY FEATURES

(71) Applicants: Susan L. Kimmel, Washington, DC (US); Louis Tenenbaum, Kensington, MD (US); Seymour Turner, Chicago, IL (US); Rob Germain, Arlington, VA (US)

(72) Inventors: Susan L. Kimmel, Washington, DC (US); Louis Tenenbaum, Kensington, MD (US); Seymour Turner, Chicago, IL (US); Rob Germain, Arlington, VA (US)

(21) Appl. No.: 18/149,977

(22) Filed: Jan. 4, 2023

Related U.S. Application Data
(60) Provisional application No. 63/266,379, filed on Jan. 4, 2022.

(51) Int. Cl. G09B 19/00; G06T 7/00; G09B 5/02

(52) U.S. Cl. CPC G09B 19/003; G06T 7/0004; G09B 5/02

(57) ABSTRACT

A method for determining the location and installation techniques of accessibility features that employs a photo-documentation quality control function to ensure compliance with the norms associated specifically with the client, the type of accessibility feature, and the existing structure that accessibility feature is to be installed into.

### CROSS-REFERENCE TO RELATED APPLICATION

This application claims the benefit of priority of U.S. provisional application No. 63/266,379, filed Jan. 4, 2022, the contents of which are herein incorporated by reference.

### BACKGROUND OF THE INVENTION

The present invention relates to residential and commercial modifications and, more particularly, a system for determining the location and installation techniques for accessibility features, wherein the system verifies compliance with the identified installation techniques through a photo-documentation method.

For older adults who wish to age in place or physically disabled individuals who desire independence, their home may require the installation of accessibility features, including but not limited to grab bars, ramps, railings, and the like. Currently there is no efficient process for doing so because, in part, of the following problems: the contractor/handyman does not know the best location or best method of installation; an occupational therapist is consulted but this is an additional step and cost which requires follow up by the homeowner; and there is no means of verification that the work was completed properly whether performed by a contactor or as a do-it-yourself project.

No doubt, there are countless online videos, but their inconsistent instructions are frequently over-generalized or specific to one manufacturer leading to confusion, for the non-professional, as to the appropriate method. In addition, videos demonstrating how to install grab bars do not consider the client's physical condition or special needs. Specifically, the standards for placement (e.g., under the ADA) in such online videos are geared for the general public and not for a given individual. And none of the current solutions verify the adequacy of the installation. In short, while there may be online videos for installation of accessibility features, they are not adapted to the particular requirements of a given individual nor the dimensions, configuration, and building materials of that individual's dwelling.

Furthermore, current software application solutions do not provide a method of determining and verifying an accessibility feature was properly located and installed based on the three most salient variables: the client, the type of accessibility feature, and the existing structure into which the accessibility feature is to be installed.

Determining the proper location and installation techniques of accessibility features for a unique individual currently requires the expertise of an occupation therapist and an on-site inspection of a licensed contractor or carpenter, which adds time and monetary costs.

As can be seen, there is a need for a method for determining the location and installation techniques of accessibility features that employs a photo-documentation quality control function to ensure compliance with the norms associated specifically with the client, the type of accessibility feature, and the existing structure that accessibility feature is to be installed into.

### SUMMARY OF THE INVENTION

The method embodied in the present invention receives input information about the client and the existing configuration of the home to determine a suitable accessibility feature. The method further determines the associated structural data (e.g., wall and substrate construction) of the job site to identify a set of installation instructions adapted for the number, size, location, and appropriate installation hardware for the identified accessibility feature. In addition, the present invention uses photo documentation to verify step-by-step that the installation work was performed in accordance with the instructions.

The present invention may employ artificial intelligence and machine learning to automate functions currently performed by professionals as well as enable the photo-documentation quality control function.

In one aspect of the present invention, a method includes the following: receiving, by a processor, client data; recording, by the processor, sensed electromagnetic waves indicating site configuration data of a job site; determining, by the processor, that the site configuration data in view of the client data includes compliant information in compliance with one or more accessibility feature solutions retrievably stored in a database; identifying, by the processor, a set of installation instructions for a accessibility feature associated with a compliant accessibility feature solution, wherein the set of installation instructions is based on the site configuration data; and displaying, by the processor, a plurality of steps of the set of installation instructions sequentially only if an electromagnetically sensed documentation is received by the processor for each step.

In another aspect of the present invention, the method further includes, wherein the electromagnetically sensed documentation is a captured image; and further includes displaying by the processor, a job space based on the site configuration data; identifying, by the processor, a location of the accessibility feature along the job space based on the client data and the site configuration data, wherein the location is displayed, by the processor, on the job space; receiving, by the processor, a pre-installation captured image of one or more location points marked on the job site based on said location of the accessibility feature; display, by the processor, of the set of installation instructions is conditioned on the one or more location points aligning said location of the accessibility feature, wherein the site configuration data includes a location of obstructions and accessory features associated with the accessibility feature, wherein determining that the client data and the site configuration data include compliant information comprises determining that the client data is within feature specification parameters of at least one accessibility feature solution and that the accessibility feature associated with each at least one accessibility feature solution is categorized as a suitable for installation in the job site based on the site configuration data, wherein the plurality of steps of the set of installation instructions includes one or more structural data collection steps displayed by the processor, and wherein the plurality of steps of the set of installation instructions includes a final step; and transmitting, by the processor, a certificate of compliance upon the processor receiving an electromagnetically sensed documentation related to the final step.

These and other features, aspects and advantages of the present invention will become better understood with reference to the following drawings, description, and claims.

### BRIEF DESCRIPTION OF THE DRAWINGS

FIG. 1 is a schematic view of an exemplary embodiment of the present invention. It should be understood that even through the Figures represent and note an exemplary grab bar to demonstrate how the present invention would be used for the installation, other accessibility features are contemplated (including but not limited to handrails, ramps, etc.).

FIG. 2 is a schematic view of an exemplary embodiment of the present invention.

FIG. 3 is a schematic view of an exemplary embodiment of the present invention.

FIG. 4 is a schematic view of an exemplary embodiment of the present invention.

FIG. 5 is a schematic view of an exemplary embodiment of the present invention.

FIG. 6 is a schematic view of an exemplary embodiment of the present invention.

FIG. 7 is a schematic view of an exemplary embodiment of the present invention.

FIG. 8 is a schematic view of an exemplary embodiment of the present invention.

FIG. 9 is a schematic view of an exemplary embodiment of the present invention.

FIG. 10 is a schematic view of an exemplary embodiment of the present invention.

FIG. 11 is a schematic view of an exemplary embodiment of the present invention.

FIG. 12 is a schematic view of an exemplary embodiment of the present invention.

FIG. 13 is a schematic view of an exemplary embodiment of the present invention.

FIG. 14 is a schematic view of an exemplary embodiment of the present invention.

FIG. 15 is a schematic view of an exemplary embodiment of the present invention.

FIG. 16 is a schematic view of an exemplary embodiment of the present invention.

FIG. 17 is a schematic view of an exemplary embodiment of the present invention.

FIG. 18 is a schematic view of an exemplary embodiment of the present invention.

FIG. 19 is a schematic view of an exemplary embodiment of the present invention.

FIG. 20 is a schematic view of an exemplary embodiment of the present invention.

FIG. 21 is a schematic view of an exemplary embodiment of the present invention.

FIG. 22 is a schematic view of an exemplary embodiment of the present invention.

FIG. 23 is a schematic view of an exemplary embodiment of the present invention.

FIG. 24 is a schematic view of an exemplary embodiment of the present invention.

FIG. 25 is a schematic view of an exemplary embodiment of the present invention.

FIG. 26 is a schematic view of an exemplary embodiment of the present invention.

FIG. 27 is a schematic view of an exemplary embodiment of the present invention.

FIG. 28 is a schematic view of an exemplary embodiment of the present invention.

FIG. 29 is a schematic view of an exemplary embodiment of the present invention.

FIG. 30 is a schematic view of an exemplary embodiment of the present invention.

FIG. 31 is a schematic view of an exemplary embodiment of the present invention.

FIG. 32 is a schematic view of an exemplary embodiment of the present invention.

FIG. 33 is a schematic view of an exemplary embodiment of the present invention.

FIG. 34 is a schematic view of an exemplary embodiment of the present invention.

FIG. 35 is a schematic view of an exemplary embodiment of the present invention.

FIG. 36A is a flowchart overview of an exemplary embodiment of the present invention.

FIG. 36B is a continuation of FIG. 36A.

FIG. 37 is a flowchart view of an exemplary embodiment of the present invention.

FIG. 38 is a flowchart view of an exemplary embodiment of the present invention.

FIG. 39A is a flowchart view of an exemplary embodiment of the present invention.

FIG. 39B is a continuation of FIG. 39A.

FIG. 40A is a flowchart view of an exemplary embodiment of the present invention.

FIG. 40B is a continuation of FIG. 40A.

FIG. 41 is a flowchart view of an exemplary embodiment of the present invention.

FIG. 42A is a flowchart view of an exemplary embodiment of the present invention.

FIG. 42B is a continuation of FIG. 42A.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a method for determining the location and installation techniques of accessibility features coupled to a system for verifying compliance with the identified installation techniques.

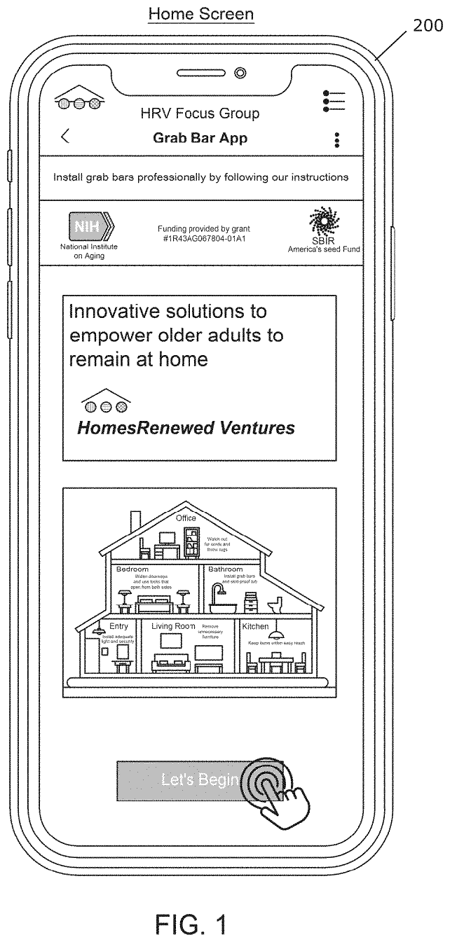

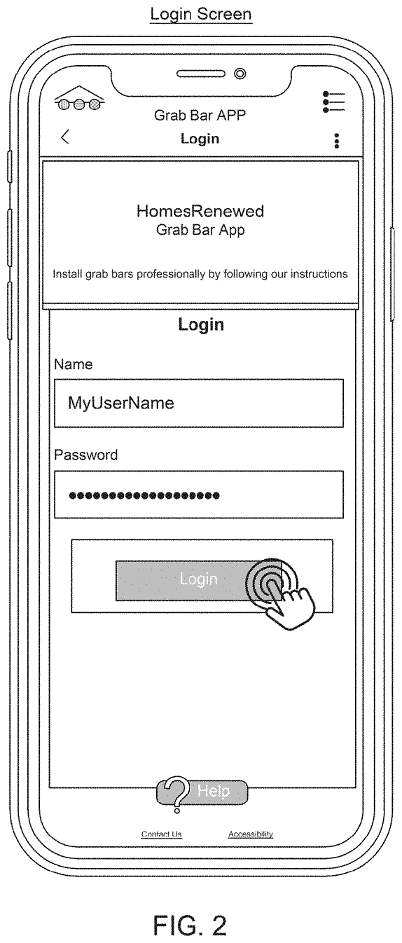

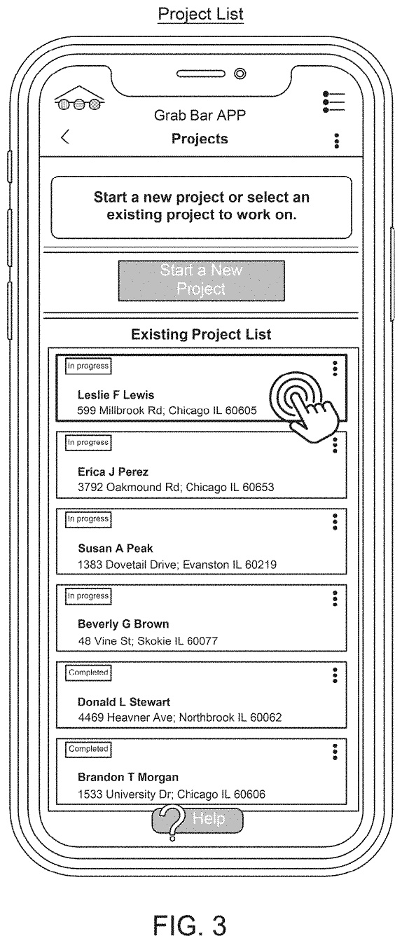

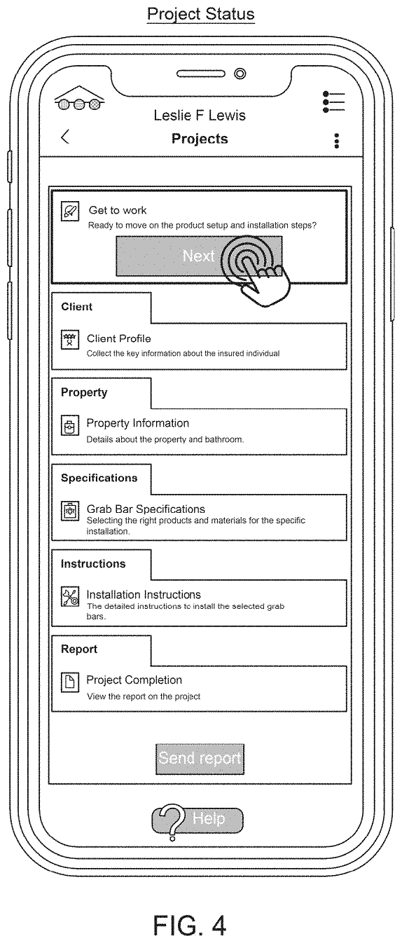

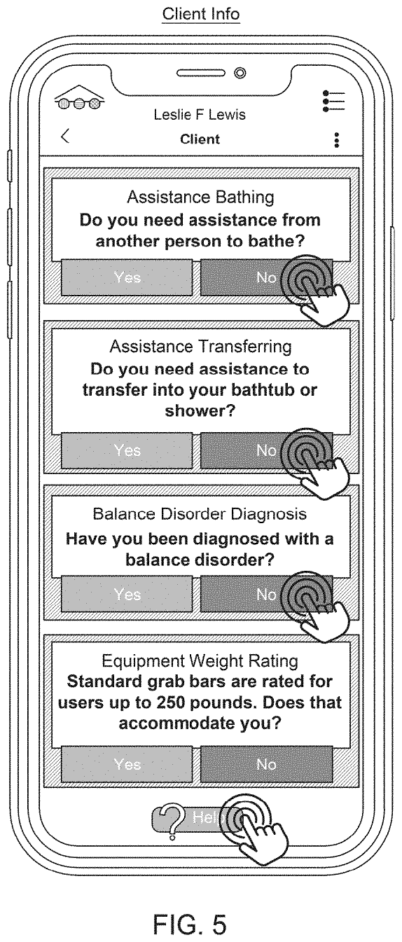

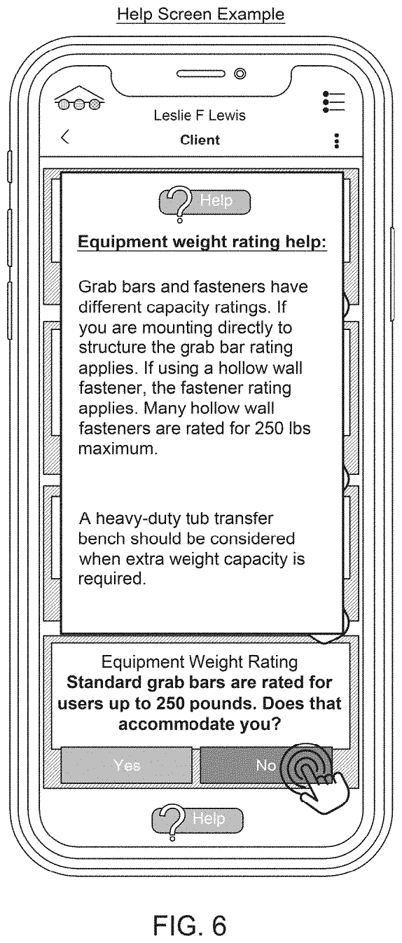

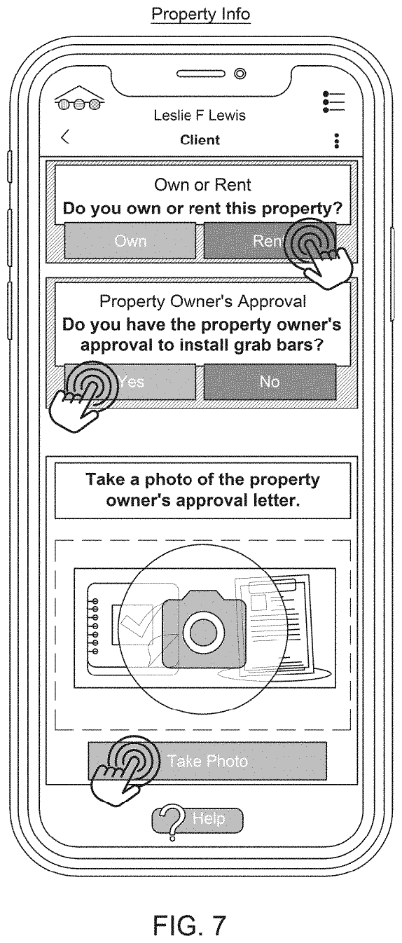

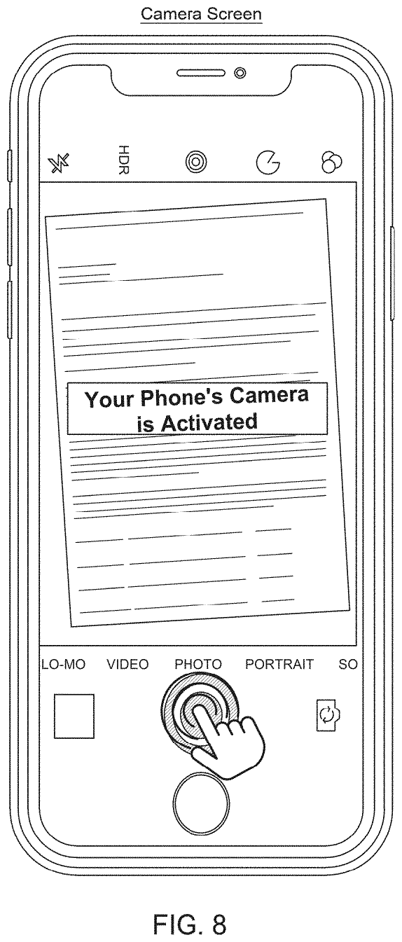

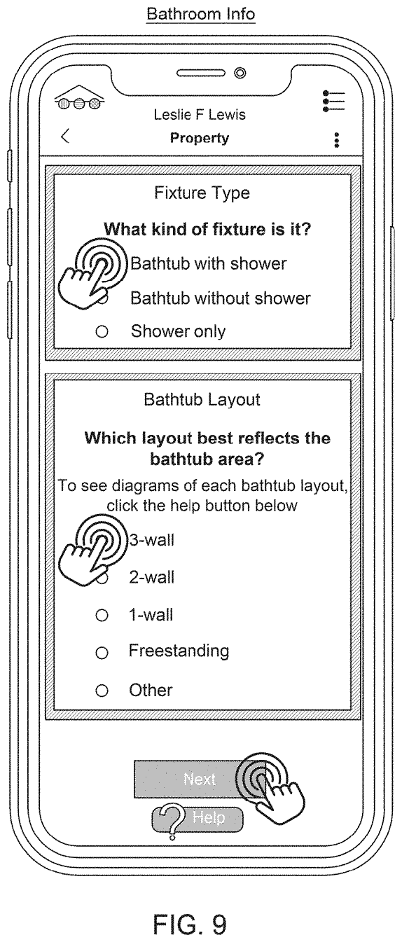

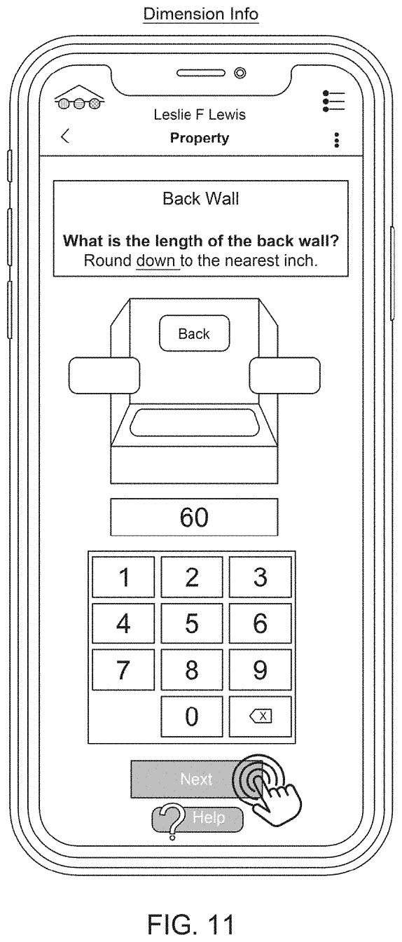

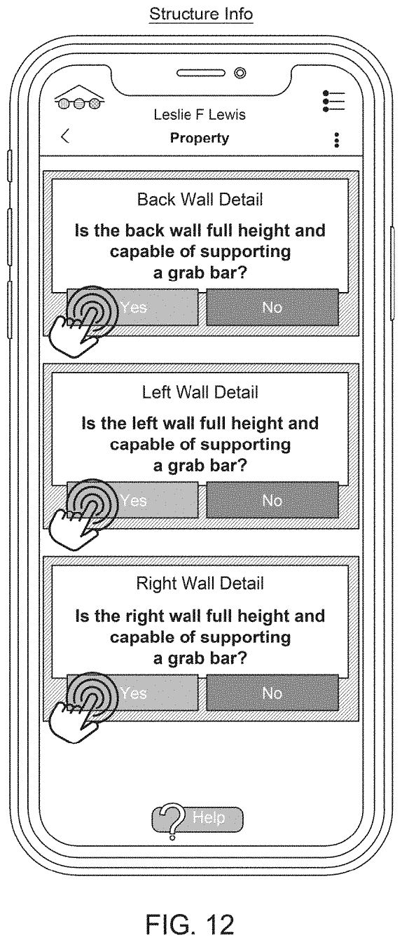

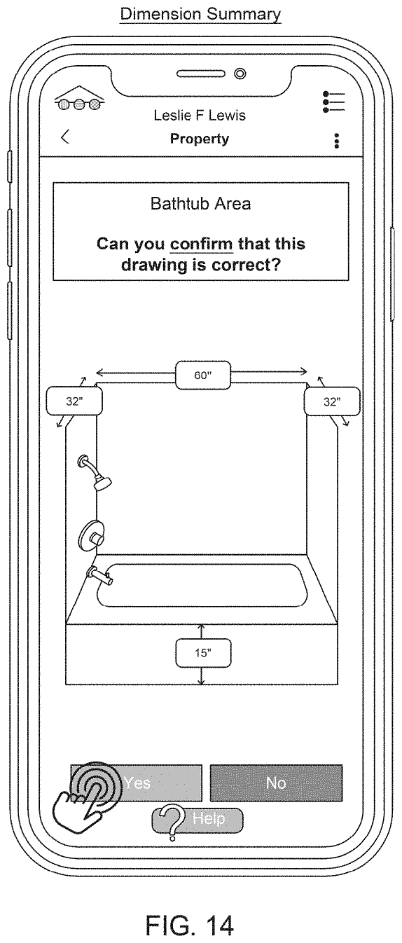

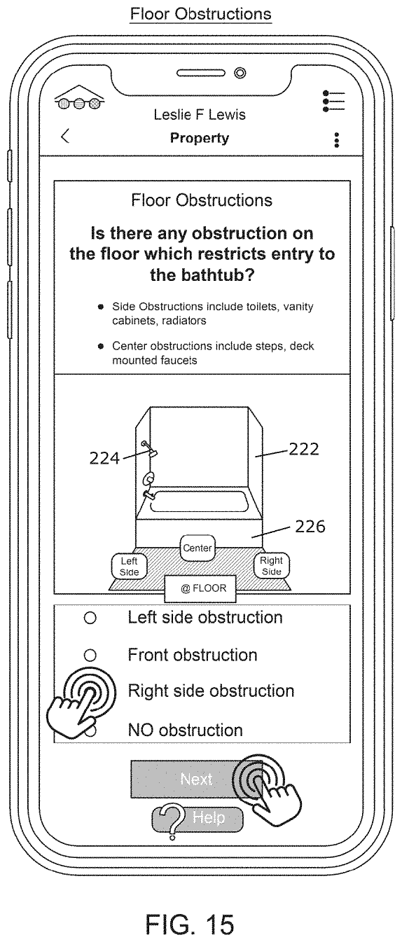

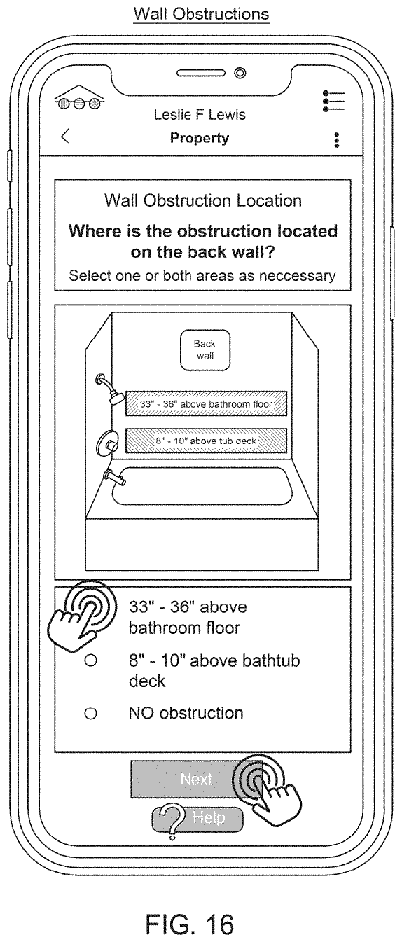

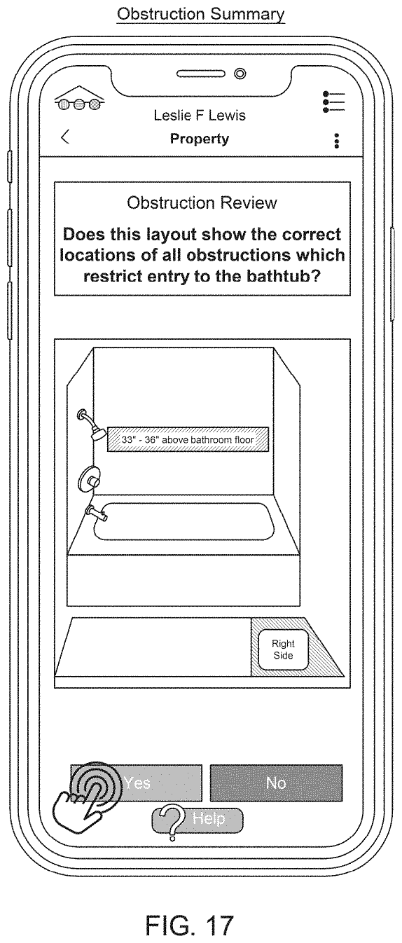

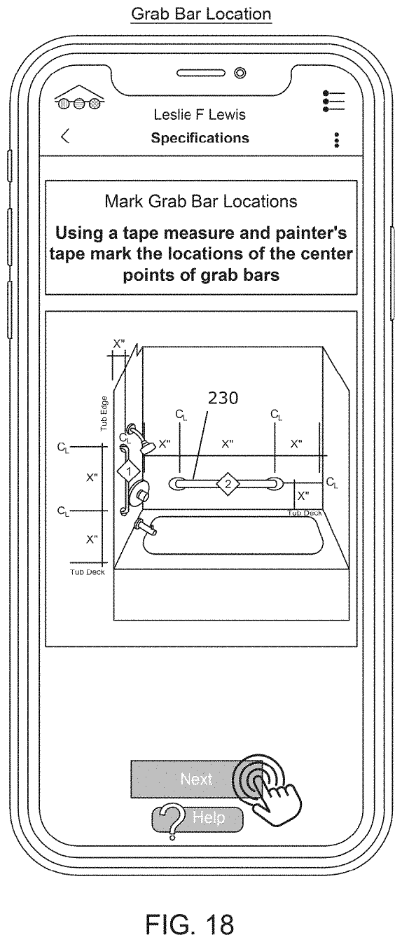

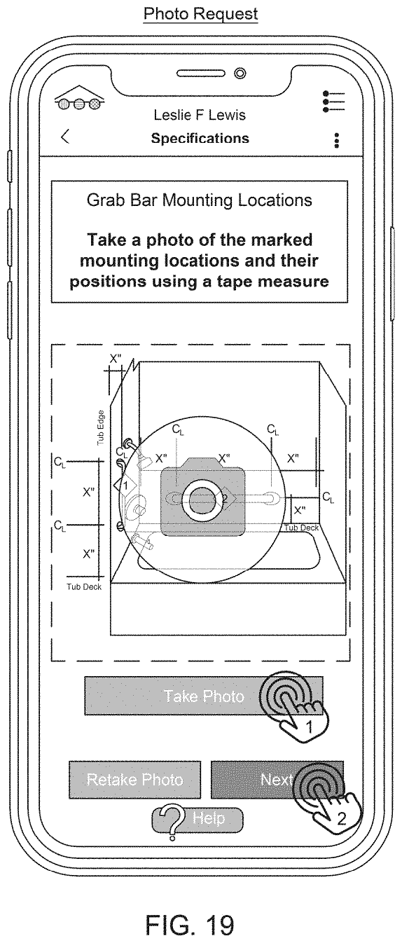

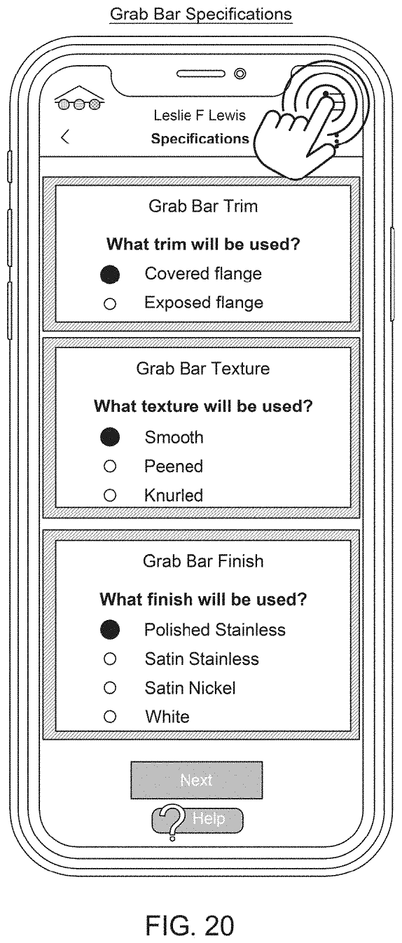

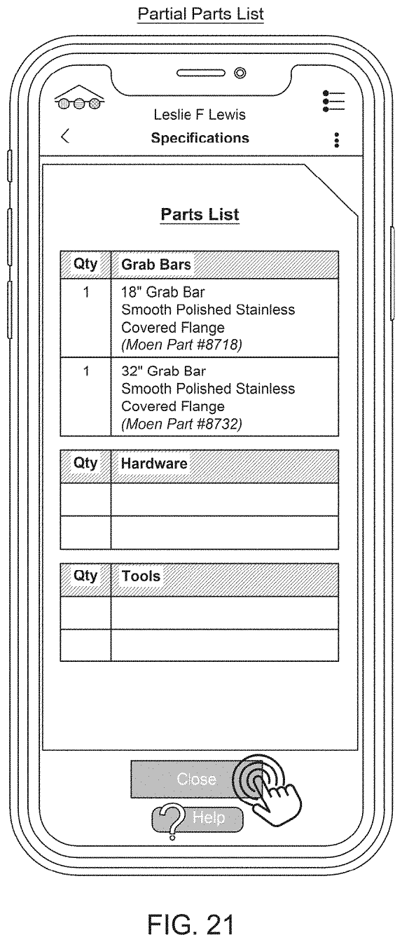

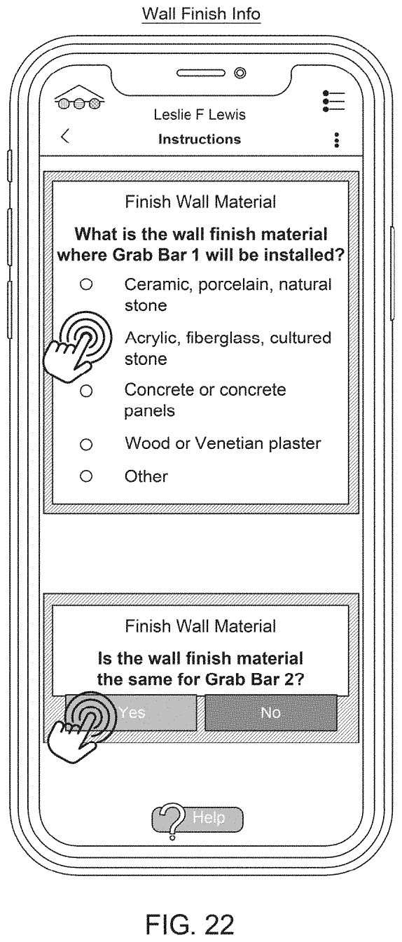

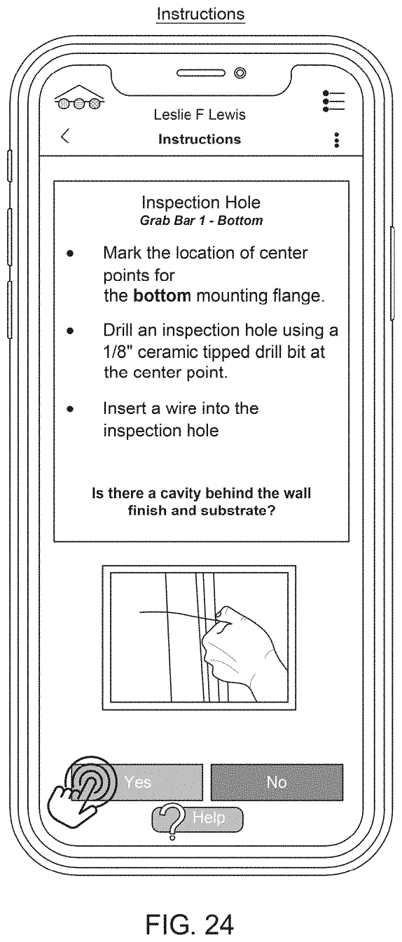

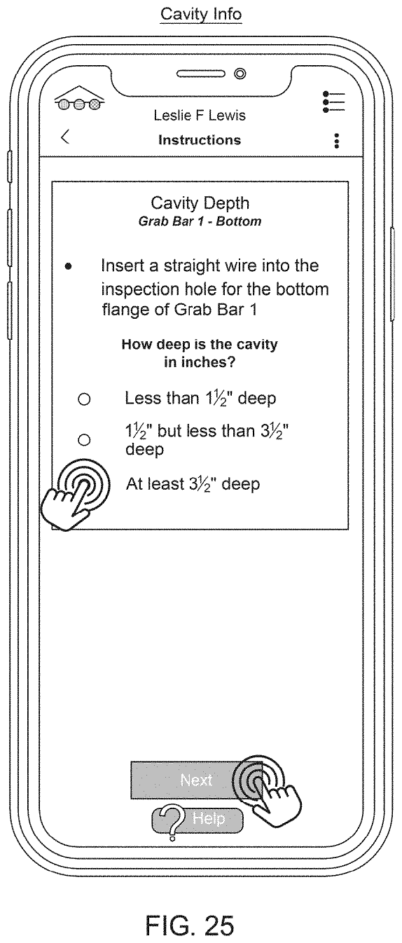

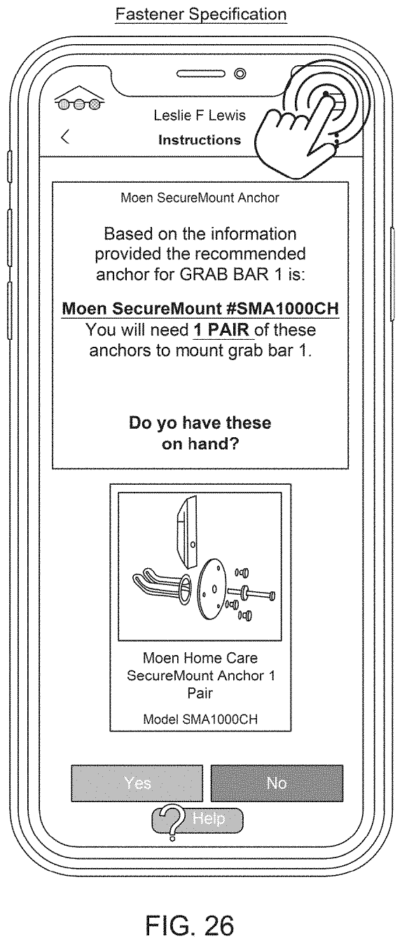

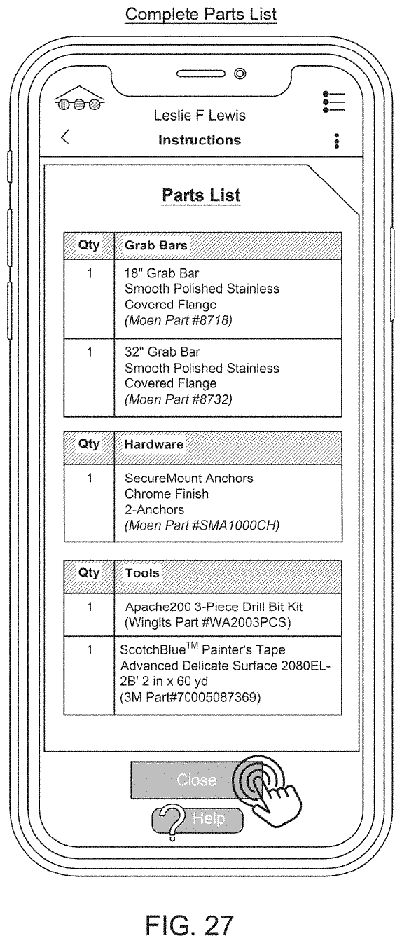

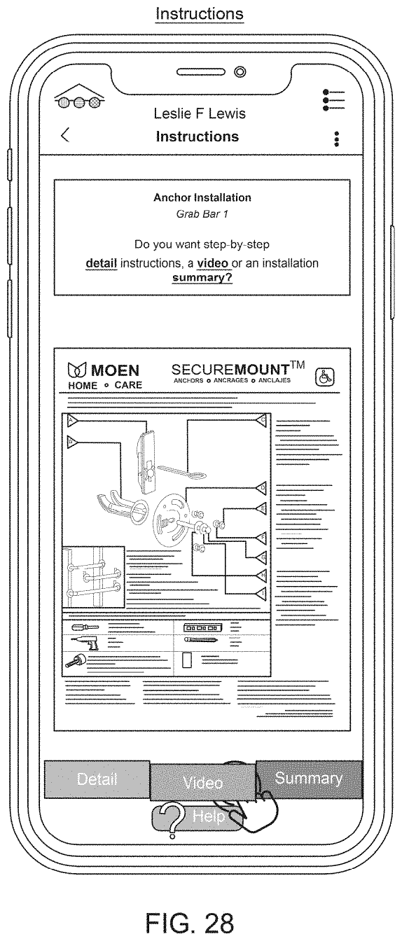

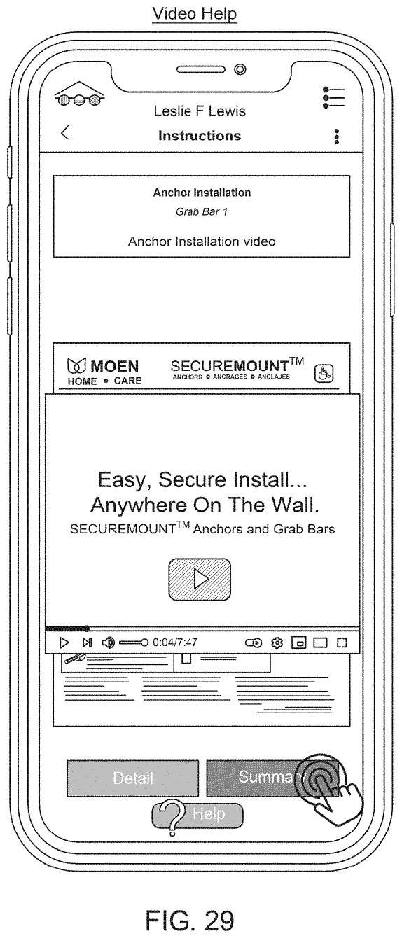

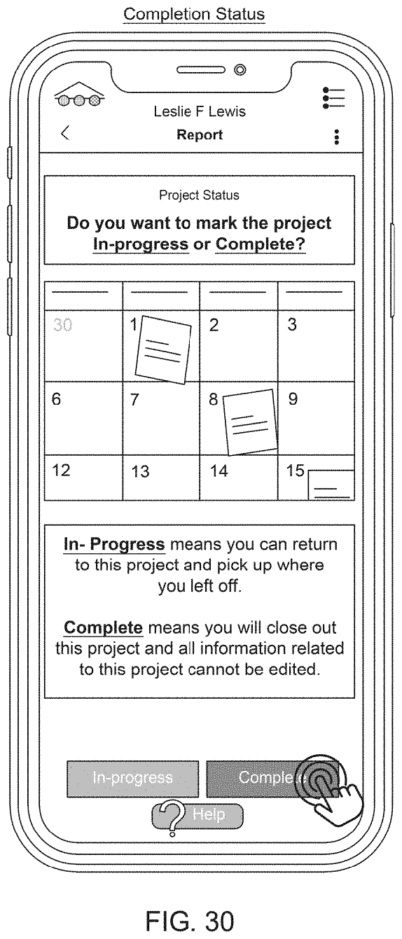

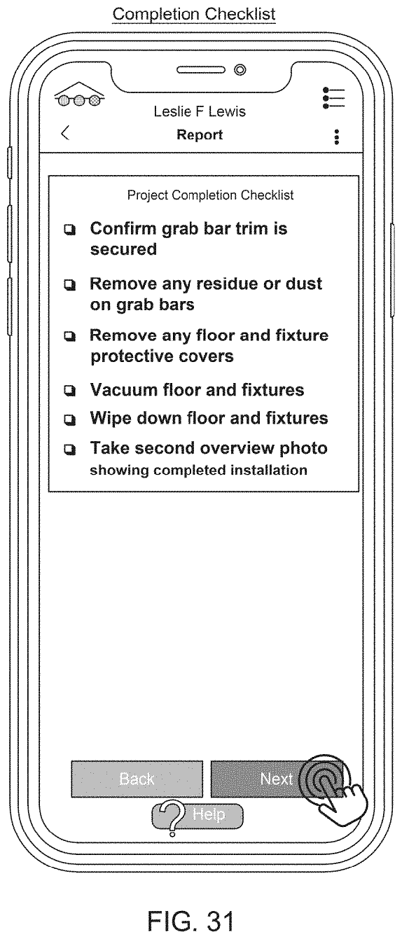

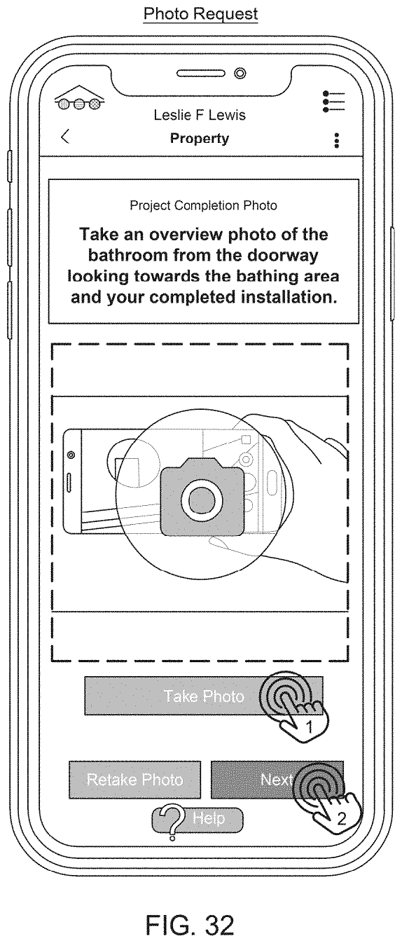

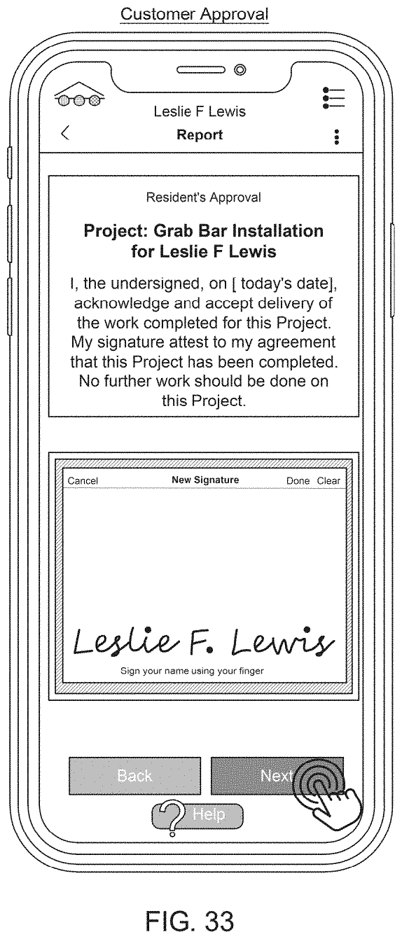

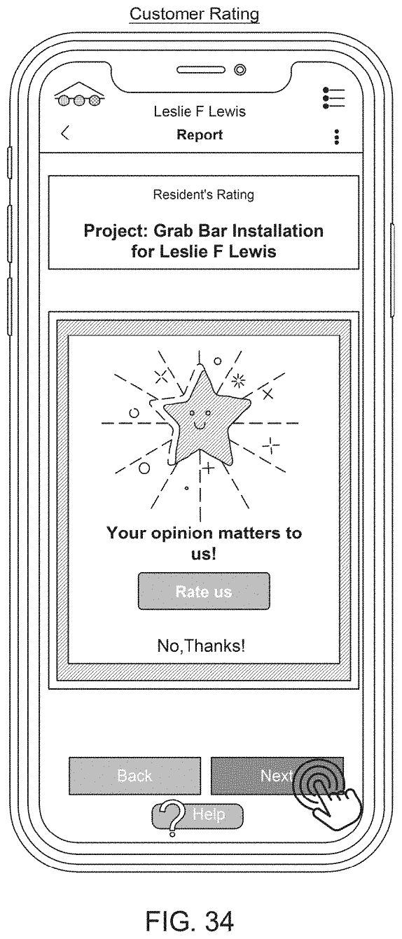

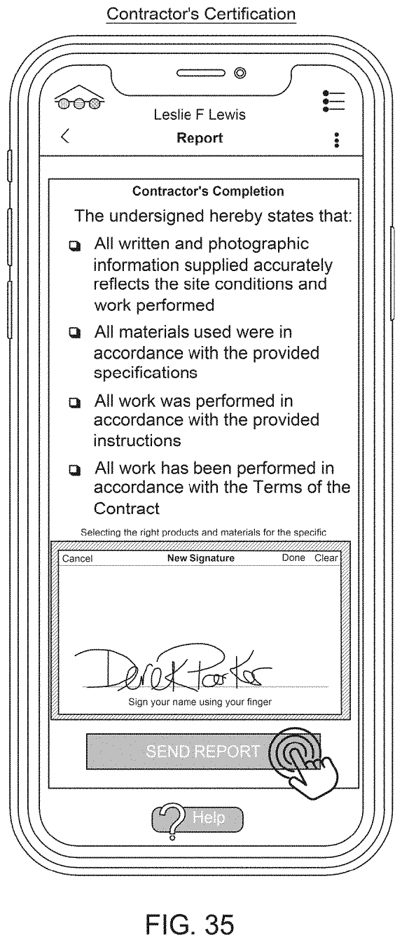

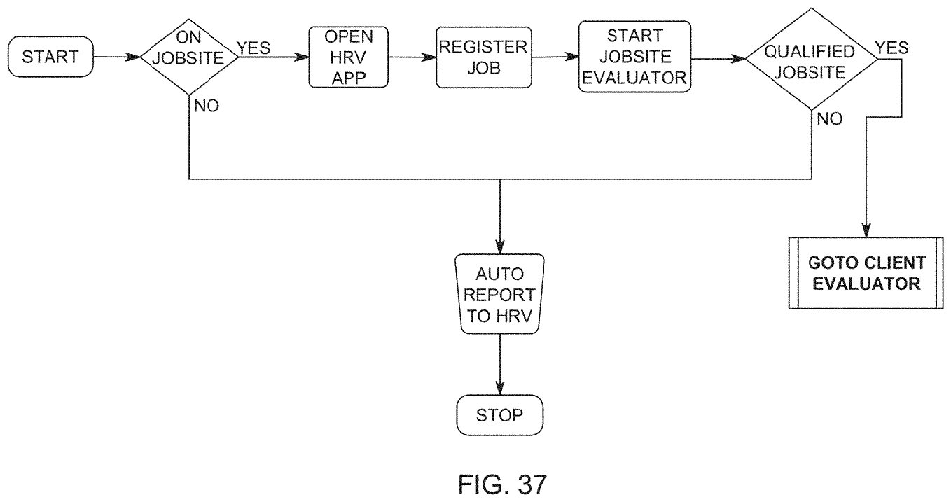

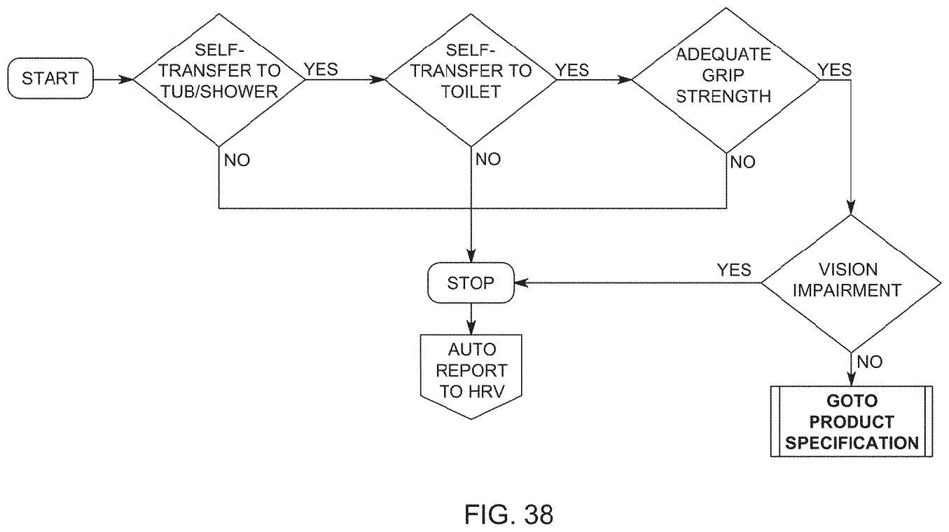

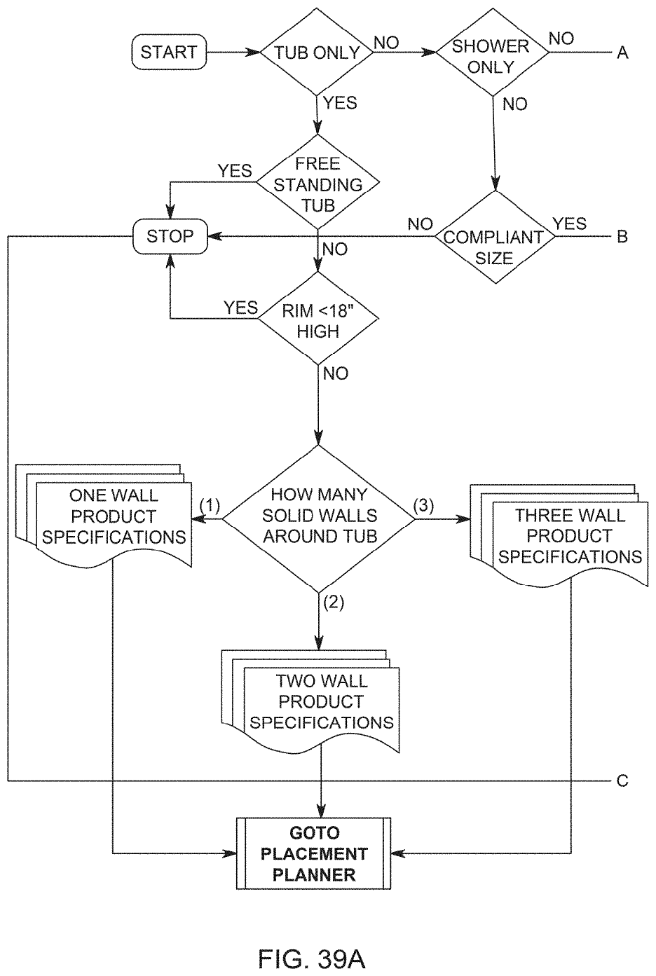

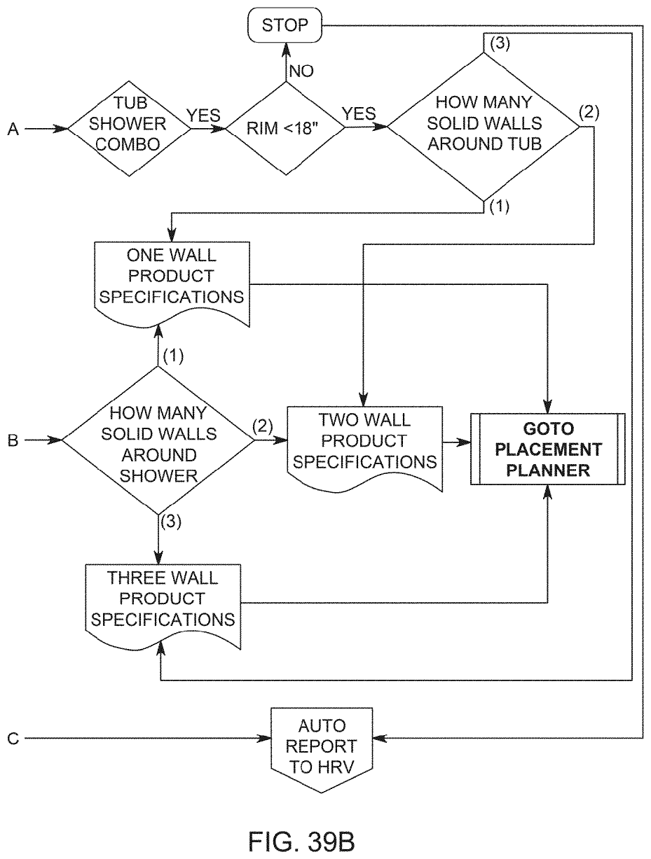

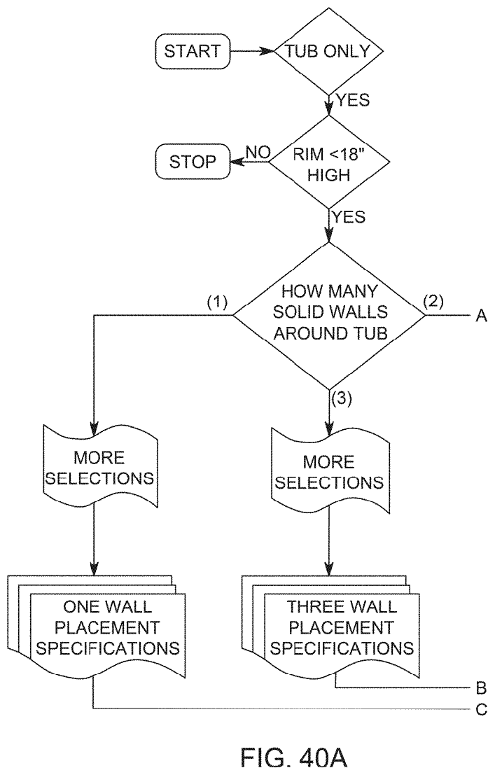

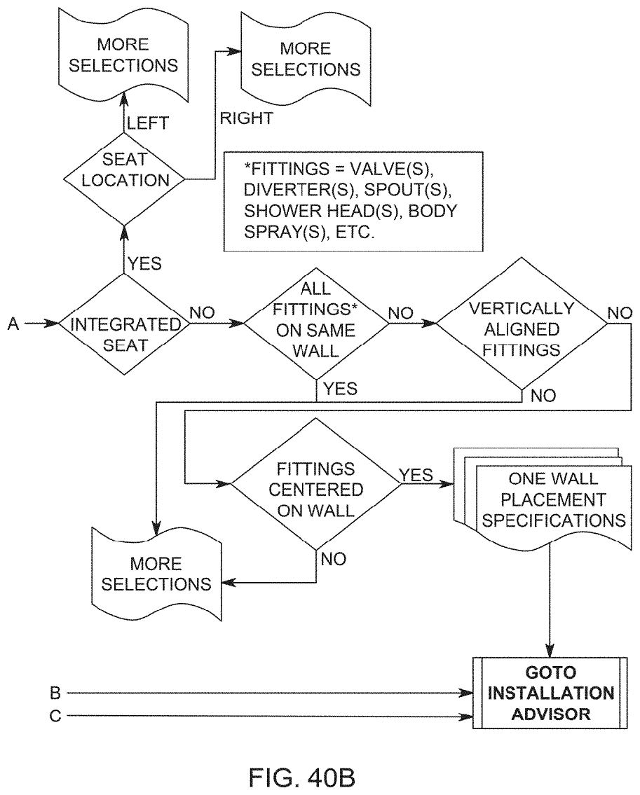

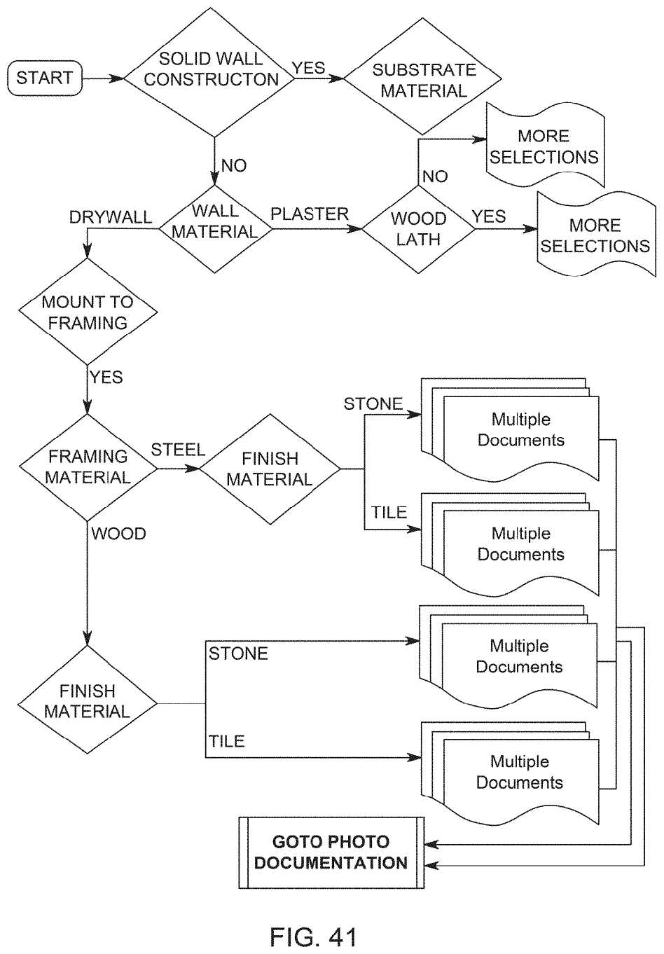

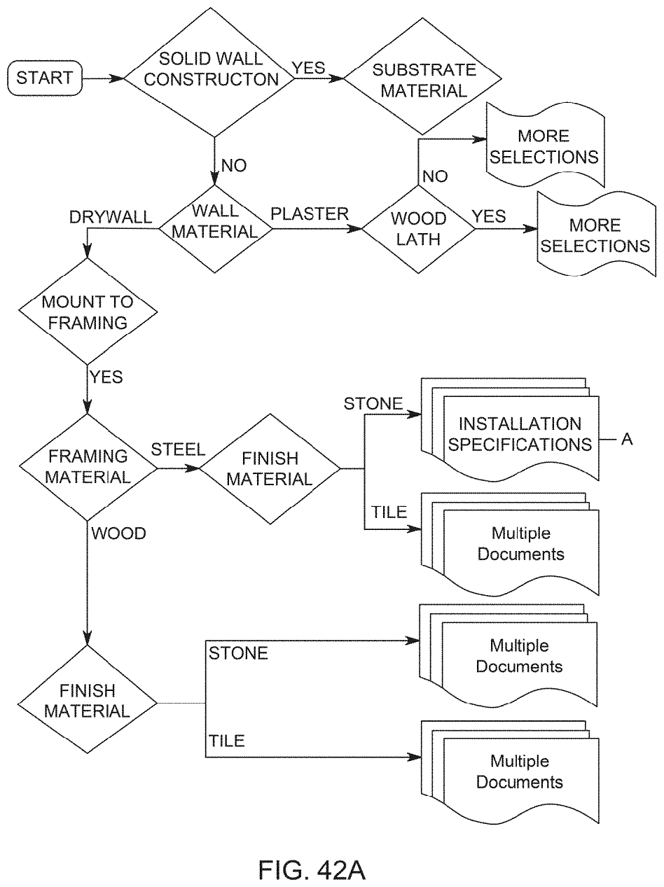

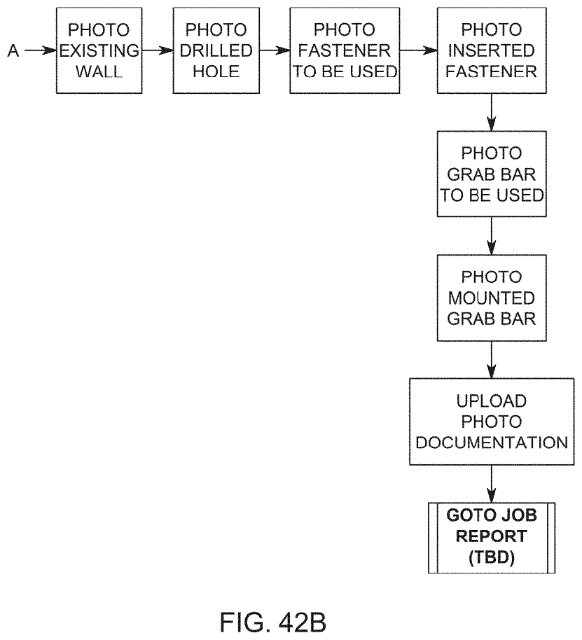

Referring now to FIGS. 1 through 42B, the present invention may include one or more computer programs that are executable on a computer system including at least one processor coupled to receive data and instructions from, and to transmit data and instructions to, a data storage system, at least one input device, and at least one output device. The input devices may include but are not limited to an image-capturing device or other electromagnetic wave sensing device (such as LIDAR) and, separately, a user interface operatively associated with the display of the computing system, and possibly electronic measuring tools. Each computer program can be implemented in any suitable manner, including via a high-level procedural or object-oriented programming language and/or via assembly or machine language. Systems of the present disclosure may include, by way of example, both general and special purpose microprocessors which may retrieve instructions and data to and from various types of volatile and/or non-volatile memory. Computer systems operating in conjunction with the embodiments of the present disclosure may include one or more mass storage devices for storing data files, which may include: magnetic disks, such as internal hard disks and removable disks; magneto-optical disks; and optical disks. Storage devices suitable for tangibly embodying computer program instructions and data (also called the “non-transitory computer-readable storage media”) include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware. The computer systems may include smartphones, tablets, or other similar devices.

FIGS. 1-35 shows an example of a system according to one embodiment of this disclosure. In this example, the computing system 200 may be a smartphone loaded with systemic software, for example, downloaded from a network provider and installed in the phone or, in some embodiments, pre-installed in the phone by the manufacturer.

The computing system 200 may be connected, either by wired or wireless connection, to a network (e.g., the cloud) coupled to a database 100, wherein the database 100 hosts of dynamic link library (DLL) or collection of small programs, not already residing on the computing system 200, that the systemic software programs can load when needed to complete specific tasks disclosed herein. Though in other embodiments, the software application and the database may reside in a terminal computing system or handheld computing device so that Internet connection is not required for the present invention to function.

The user interface may prompt users for information about the three (3) systemic variables: (1) the client data, (2) the accessibility feature data, and (3) the structural data of the existing structure into which that accessibility feature is to be installed.

Client data may be input through the user interface in the form of user answers to queries or list offerings. Client data may include information about the client's physical limitations for one or more self-care activities, and relatedly diagnosed disorders, the client's weight, the client's height, the client's age, and so on, as well as registration information. Client data may include site configuration data regarding the job site in which the accessibility feature installation is contemplated.

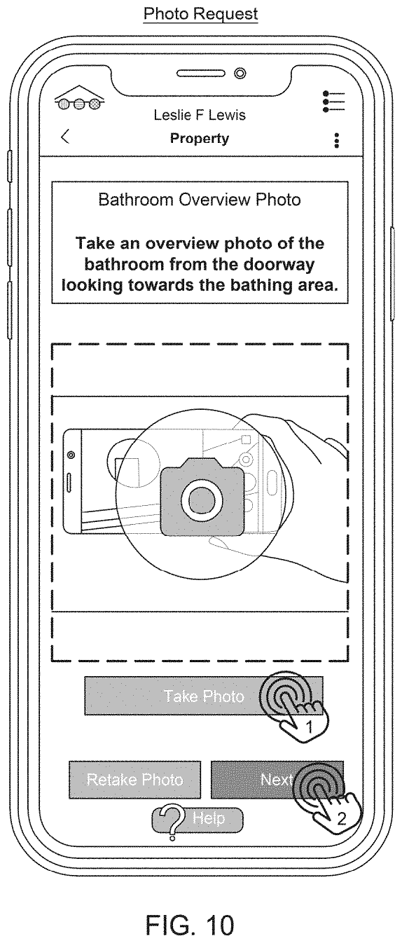

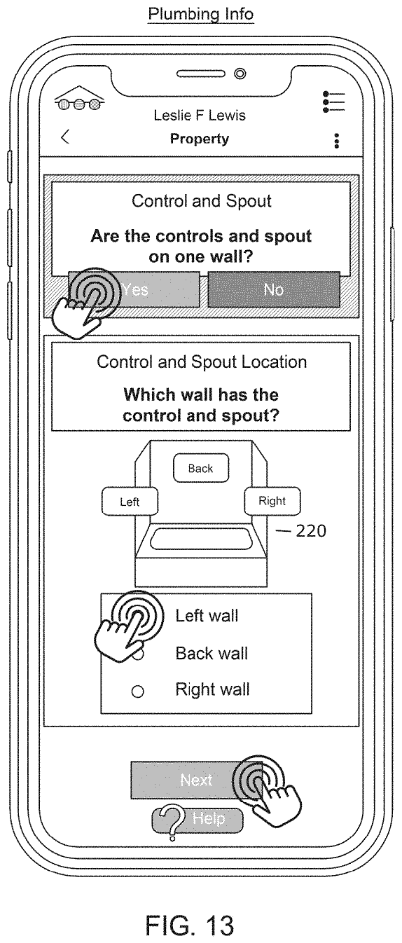

The site configuration data related to the existing structure can be captured and received via the electromagnetic sensing device of the computing system 200 in conjunction with data input through the user interface. For instance, a first configuration data set may be collected through queries via the user interface. The first configuration data may include the identification of space type (e.g., bathroom, stairwell, front entrance) to receive the accessibility device. The first configuration data set may include information regarding the configuration of the job stie space, such as the number, location, and dimensions of defining walls and possibly obstructions (e.g., handrail extends into hallway, grab bar intersects soap dish, etc.). The first configuration data may include the location of associated pre-existing features, such as the location of a control and spout location for a bath. A second configuration data set may be obtained through the electromagnetic wave sensing device (e.g., image-capturing device) capturing an image of the job site, as illustrated in FIG. 10. The present invention may be configured to evaluate the first and second configuration data sets and render therefrom a representative image of the job space 220 on the display of the computing system 200, as illustrated in FIGS. 13-19. The virtual job space 220 may include representations of the structure (objects, walls, and floor) 222, associated pre-existing features (e.g., spouts and controls) 224, and obstructions 226 dimensionally accurately (proportional) relative to the job site as provided by the first and second site configuration data sets.

Based on the client data, the software may prompt the user to select from a menu of different types of suitable accessibility features. For instance, if there is an indication in the client data that the user has physical limitation in or around a bathroom facility, (e.g., entering and existing a bath), the software may provide the user with different types of accessibility features that can aid them in self-care activities related to the bathroom facilities.

The present invention may provide data table comparison capabilities, or a comparator module, adapted to compare the first and second configuration data sets to the contents of a look-up table where one or more viable accessibility features may be identified. The look-up tables are a part of a knowledge base/libraries (DLLs) which contains various tables and data accessed by the system residing, in certain embodiments, in the database 100. The tables and data may provide compliance information using and feature specifications regarding generic types of accessibility features developed by experts in specialty fields (occupational therapy, architecture, construction), wherein compliance may be determined by client data (e.g., user weight, height, handiness, etc.) is within parameters defined by said feature specification for an accessibility feature solution categorized as providing an accessibility feature suitable for job site installation based on the site configuration data (e.g., space tolerances, supporting structural component requirements, etc.).

The present invention may employ artificial intelligence and machine learning to identify the most suitable accessibility feature (“item”) 230 as well as provide suitable installation locations within job space 220. The identified item 230 and its coordinates 232 or location relative to the structures 222, features 224 and any obstructions 224 may be represented on the display of the job space 220. The present invention may prompt the user to mark installation locations (e.g., end and center points) of the item 230 along the existing structure of the job site based on the accessibility feature/item 230 specifications identified by the present invention. The present invention may prompt the user to capture a pre-installation documentation image of the installation locations made by the user, thereby verifying the suitability of the identified item 230. The pre-installation documentation image may amount to a node in an if-then decision tree for determining compliance between an identified item's installation location and the real-world components of the existing structure.

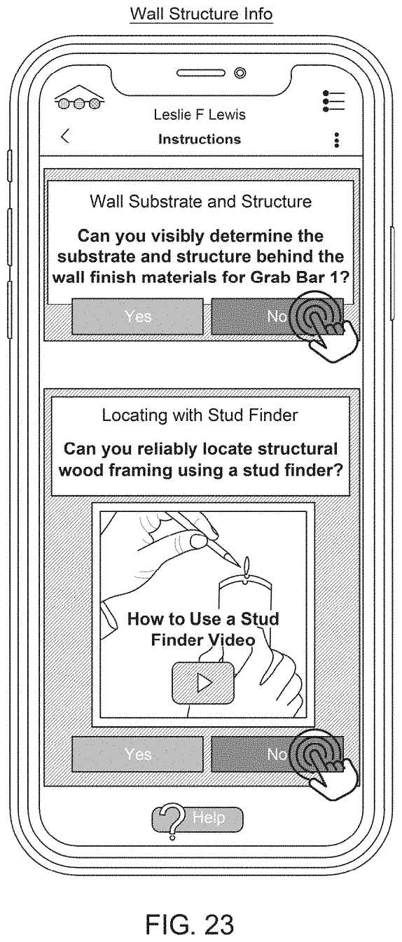

The present invention may receive structural data of the physical job site. Structural data includes material types and subcomponents of the structural components 222 determined through the client data's site configuration data set. As illustrated in FIG. 23, through the user interface, the present invention may further prompt the user to answer questions about the material type of a given structural component 222, such as a wall of a bath, that has been identified for installation of the item 230. To wit, the present invention may instruct the user on how to ascertain non-visible or substrate materials that are not readily ascertainable. Similarly, the present invention may prompt the user to input substrate and subcomponent information regarding the identified structural component 222. The structural data may be supplemented by a data received from the sensing/input devices of the computing system 200, such as one or more structural photo documentation.

The present invention may provide installation techniques (a set of installation instructions) as a function of the client data, the identified item 230 specifications, and the structural data. For instance, the installation instructions may include a plurality of steps ending with a final step, wherein each step is based on the earlier identified item 230 and the structural data. After each step of installation, the user may be prompted to provide a related installation-step documentation image 132, 136, 144, 148, etc.

The software application is configured to evaluate each installation-step documentation image for compliance with installation instructions given for that step. The software application is configured so that if there is a variation or variance with (i.e., an installation step is not in compliance), corrective instructions or workaround are provided if necessary. Each corrective action or workaround step results in a prompt for a related documentation image, which in turn is reviewed for compliance. The software application may be configured to issue a certificate of completion in compliance with all the steps of a set of installation instructions.

The software application embodied in the present invention enables secure installation of accessibility features (collectively, “items”) with appropriate placement for use by non-professional users in their own residence. While intended for remodeling projects in private homes, the software application may also be used for new construction and for either new or remodeling of multifamily or institutional (e.g., nursing home) facilities.

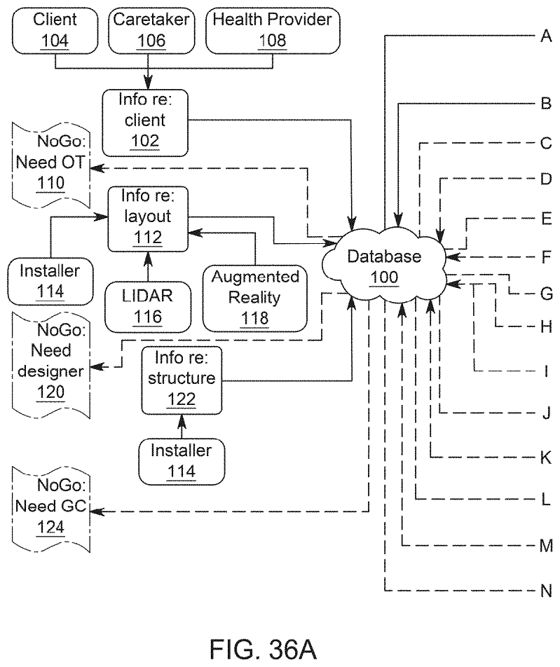

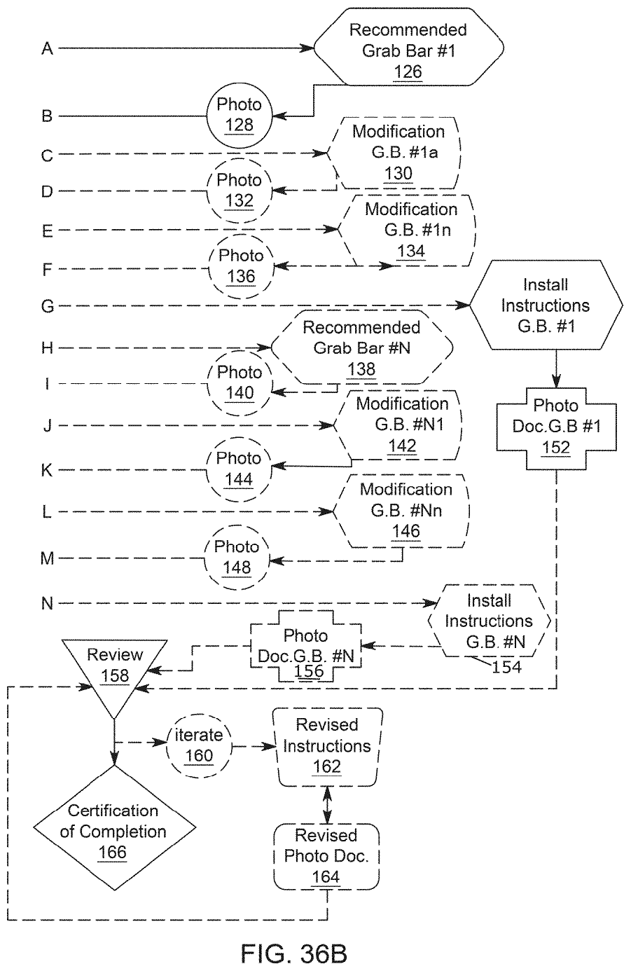

Referring to FIGS. 36A through 42B, a user of a systemic computing device has access to a database 100 which contains an extensive library (DLLs) of generic types and specifications of grab bar, handrail, ramp, and other accessibility feature solutions generated by a team of experts including contractors, occupational therapists (OTs), geriatricians, universal design specialists, architects, and others.

This reference material is then fine-tuned and customized in response to the specific inputs about the client and the job site. The present invention optimizes the solution to variables presented in the form of the client data, accessibility feature data, and site structural data.

The client data may include information inputted by the resident 102 regarding themselves 104, the site configuration 112, and the wall construction and materials (structural data) 122, which may be hidden building components behind the wall—e.g., plumbing pipes, air ducts, electrical conduit.

The client data, accessibility feature specification data, and structural data comprise the specific inputs couplable with programs from the library database 100 to determine a suitable accessibility feature for each client at each job site. The client data may include inputs from the client (the end-user of the feature) job site owner 102, by the client him/herself 104, a caretaker or family member 106, and in some instances medical records submitted by a healthcare provider, discharge planner or hospital 108.

The structural 122 data may include site configuration data 112 obtained by installer 114 on site with inputs obtained by observation, as disclosed above, and recorded photographically using the electromagnetic wave sensing device which may include a camera, LIDAR 116 and/or augmented reality 118. The structural data is related to the functional integrity of the job site as observed and tested by the installer 114, as disclosed above.

The software application may provide a comparator module that is configured to compare the client data, item specifications, and structural data sets of a specific case to the norms as collected in the database 100 library (DLL) so as to determine a suitable accessibility feature or, alternatively, which cases are beyond the capabilities of the software application to derive a solution on the basis of one or more factors to screen out those to be referred to the appropriate expert, an occupational therapist 110, architect or interior designer 120, or general contractor

The software provides clear, step-by-step instructions for a recommended solution 126, 138 for installation of each item in an iterative manner with photographic feedback (e.g., installation-step image documentation) of each step 128, 132, 136, 140, 144, 148 for each item/installation step needed to provide the appropriate level of safety for a given individual (e.g., recommended grab bar 1 . . . recommended grab bar N). This process enables real-time adjustments or alternative solutions when unforeseen obstacles are encountered (e.g., an airduct being discovered where the anchoring hardware should go) 130, 134, 142, 146 (modification for item 1 . . . modification n for item 1 . . . modification n for item N). The back-and-forth process continues until all problems are resolved and an optimum location and mounting hardware are ascertained. Installation instructions would be issued for items 1 through N 150, 154. Each step of the installation process is required to be photo-documented for each and all items 152, 156. The photo documentations would be reviewed 158 and once it has been determined that the items were installed in compliance with the final step of a set of installation instructions given in terms of both appropriate placement and secure fastening, a certificate of compliance would be issued 160.

The present invention has the capability of being expanded for use with many accessibility features from grab bars, stair rails, and ramps to other modules for the types of additional home modifications which enable but is not limited to curb-less showers, stair glides, and widening doorways and hallways for wheelchair access.

The application is designed so that installers of various skill levels will receive instructions to be successful in locating and installing accessibility features to meet the needs of a particular client. The prerequisite is only that the installer be able to use power tools such as a drill. It is contemplated that measurements may be taken using LIDAR or other technology on a cell phone. Also, it is envisioned that the application would provide feedback to provide workarounds or corrections if a mistake was made or if an unexpected obstacle encountered (e.g., wiring, plumbing, heat ducts in the wall at desired location of mounting hardware).

There are several points in the process which may be considered gates or nodes in an if-then decision tree. The first is whether characteristics of the client, room layout, or wall construction are so outside the norm (outliers) that the software application cannot be used effectively for that installation. Such a determination aborts the process, and the client is referred elsewhere for advice.

Each design recommendation is based on an if-then decision tree compared to a “norm” or “generic type.” For example: 1) if the client has had a stroke impacting the right side of the body, then a grab bar would have to be within reach of the left hand; 2) If the walls surrounding the tub are at half height, requiring the grab bar would have to located lower than desired, then the installer should use a floor-to-ceiling pole exterior to the tub; 3) If the walls surrounding the tub are not strong enough to be load-bearing for a grab bar, then another installation method is needed (such as a floor to ceiling pole) or the software application may be rejected as not appropriate for the installation. The various factors determining placement, length, and anchoring of grab bars are evaluated in an iterative fashion until a solution is reached.

Critically, compliance with each set of installation instructions is documented at various steps in the process. The installer cannot proceed to the next step in the software application's set of installation instructions without first uploading a photograph of the work completed up to that point. The steps include for example: measurement, wall preparation (drilling a hole) and installation of fasteners. If found satisfactory certification is granted.

The software application can use cloud-based content management systems, reactive web design tools, security processes and custom code to implement the functionality and automation necessary to deliver the functions desired. The essential elements are: 1) the iterative processes of locating and installing the accessibility feature which would consider and adapt for any obstacles to the ideal or generic location; and 2) the photo documentation function of input, review, and approval.

At some point, the information collected about the client and the home environment could provide baseline data for studies to measure the extent to which home modifications improve the quality of life for residents, reduce the onset of requiring assistance with ADL's (activities of daily living), and save medical costs. Currently, very few of these longitudinal studies exist and even fewer are those with a controlled setting (i.e., knowing that the home improvements were properly installed).

The user (installer/handyperson/contactor) would install the software application on a portable device such as a smart phone or tablet. Using a combination of prompts, checklists, and questionnaires, the user would enter responses into the software application regarding the job site and the client. A visual inspection of the residence would establish the type and layout of elements (hallways, stairwells, exterior entrances) as well as bathroom fixtures. Entering this data into the software application, by taking measurements manually or in other embodiments using electronic measuring tools or photographically, in conjunction with basic information collected about the client would generate images indicating a recommended number and associated locations for placement of accessibility features. Additional information about obstacles (e.g., soap dish, shower door track, towel rack, etc.) would provide workaround solutions. As mentioned above, outliers will be referred to outside experts for a specific design solution for unique cases.

Once placement is determined, a set of installation instructions and visual renderings aid in assessing type of wall construction and surface materials (the user would select the best choice from a series of either static or video images of wall types and materials). This may include drawing of the accessibility feature overlaid onto a photograph of the installation site. Such a virtual visualization would enable the client (i.e., the homeowner) to participate in decisions about the improvements to his/her home. When this data is entered into the software application, the mounting hardware would be recommended along with instructions for installation. If additional obstacles are encountered (e.g., hidden plumbing, electrical, ductwork) workarounds would be provided. Each step of installation would require documentation photographically. After the uploaded photo documentation is reviewed a certificate of successful completion will be issued.

Additionally, as mentioned earlier, the software application could be used to design and install other accessibility features (curb-less shower, ramps, etc.) but may be used for nearly anything requiring detailed instructions with need for modifications as the work progresses to include such diverse activities as couturier women's clothing to substituting ingredients in cooking recipes. Somewhat similar software exists for installation of car headlamps, but it does not require workarounds, just specific information for each make, model, and year.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program (s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-Fl network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A method comprising:
receiving, by a processor, client data;
recording, by the processor, sensed electromagnetic waves indicating site configuration data of a job site;
determining, by the processor, that the site configuration data in view of the client data includes compliant information in compliance with one or more accessibility feature solutions retrievably stored in a database;
identifying, by the processor, a set of installation instructions for a accessibility feature associated with a compliant accessibility feature solution, wherein the set of installation instructions is based on the site configuration data; and
displaying, by the processor, a plurality of steps of the set of installation instructions sequentially only if an electromagnetically sensed documentation is received by the processor for each step.

2. The method of claim 1, wherein the electromagnetically sensed documentation is a captured image.

3. The method of claim 1, further comprising displaying, by the processor, a job space based on the site configuration data.

4. The method of claim 3, further comprising identifying, by the processor, a location of the accessibility feature along the job space based on the client data and the site configuration data, wherein the location is displayed, by the processor, on the job space.

5. The method of claim 4, further comprising receiving, by the processor, a pre-installation captured image of one or more location points marked on the job site based on said location of the accessibility feature.

6. The method of claim 5, wherein the display, by the processor, of the set of installation instructions is conditioned on the one or more location points aligning said location of the accessibility feature.

7. The method of claim 1, wherein the site configuration data includes a location of obstructions and accessory features associated with the accessibility feature.

8. The method of claim 1, wherein determining that the client data and the site configuration data include compliant information comprises determining that the client data is within feature specification parameters of at least one accessibility feature solution and that the accessibility feature associated with each at least one accessibility feature solution is categorized as a suitable for installation in the job site based on the site configuration data.

9. The method of claim 1, wherein the plurality of steps of the set of installation instructions includes one or more structural data collection steps displayed by the processor.

10. The method of claim 1, wherein the plurality of steps of the set of installation instructions includes a final step; and transmitting, by the processor, a certificate of compliance upon the processor receiving an electromagnetically sensed documentation related to the final step.
